(19) United States
(12) Patent Application Publication
(10) Pub. No.: US 2025/0300956 A1
(43) Pub. Date: Sep. 25, 2025

(54) MESSAGING SERVER, MESSAGING METHOD, AND NON-TRANSITORY RECORDING MEDIUM

(71) Applicant: Shohei Yonetsu, KANAGAWA (JP)

(72) Inventor: Shohei Yonetsu, KANAGAWA (JP)

(73) Assignee: Ricoh Company, Ltd., Tokyo (JP)

(21) Appl. No.: 19/058,753

(22) Filed: Feb. 20, 2025

(30) Foreign Application Priority Data
Mar. 19, 2024 (JP) 2024-042971

(51) Int. Cl. H04L 51/224; H04W 8/18; H04W 60/00

(52) U.S. Cl. CPC H04L 51/224; H04W 8/18; H04W 60/00

(57) ABSTRACT

A messaging server includes circuitry to store registration information received from each of one or more subscribers. The registration information represents a subscription setting and includes a message type of messages to be received and identification information. The message type is selected from multiple message types. The circuitry receives, from a publisher, selection of a message type from the multiple message types to be associated with a particular message to be transmitted, and selection of the identification information corresponding to the selected message type from the identification information received from the subscriber. The circuitry transmits the particular message based on the registration information and the selections by the publisher.

### CROSS-REFERENCE TO RELATED APPLICATIONS

This patent application is based on and claims priority pursuant to 35 U.S.C. § 119 (a) to Japanese Patent Application No. 2024-042971, filed on Mar. 19, 2024, in the Japan Patent Office, the entire disclosure of which is hereby incorporated by reference herein.

### BACKGROUND

### Technical Field

The present disclosure relates to a messaging server, a messaging method, and a non-transitory recording medium.

### Related Art

It is desirable to reduce unnecessary notifications regarding the online/offline (connection state) status of devices connected to a network to reduce the processing load of a server. There is a technique of performing such notification only when a condition designated by the user is satisfied. The condition is, for example, the duration of being online or offline, the time when the connection state changes, or a state change condition indicated by a state change history.

### SUMMARY

The present disclosure described herein provides a messaging server that includes circuitry to store registration information received from each of one or more subscribers. The registration information represents a subscription setting and includes a message type of messages to be received and identification information. The message type is selected from multiple message types. The circuitry receives, from a publisher, selection of a message type from the multiple message types to be associated with a particular message that is to be transmitted, and selection of the identification information corresponding to the selected message type from the identification information received from the subscriber. The circuitry transmits the particular message based on the registration information and the selections by the publisher.

The present disclosure described herein provides a messaging method that includes storing registration information received from each of one or more subscribers. The registration information represents a subscription setting and includes a message type of messages to be received and identification information. The message type is selected from multiple message types. The method includes receiving, from a publisher, selection of a message type from the multiple message types to be associated with a particular message that is to be transmitted, and selection of identification information corresponding to the selected message type from the identification information received from the subscriber. The method includes transmitting the particular message based on the registration information and the selections by the publisher.

The present disclosure described herein provides a non-transitory recording medium storing a plurality of program codes which, when executed by one or more processor, causes the processors to perform a messaging method. The method includes storing registration information received from each of one or more subscribers. The registration information represents a subscription setting and includes a message type of messages to be received and identification information. The message type is selected from multiple message types. The method includes receiving, from a publisher, selection of a message type from the multiple message types to be associated with a particular message that is to be transmitted, and selection of identification information corresponding to the selected message type from the identification information received from the subscriber. The method includes transmitting the particular message based on the registration information and the selections by the publisher.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a system configuration of a messaging system according to one embodiment of the present disclosure;

FIG. 2 is a block diagram illustrating a hardware configuration applicable to a server and an information processing terminal according to one embodiment of the present disclosure;

FIG. 3 is a block diagram illustrating a hardware configuration of an apparatus according to one embodiment of the present disclosure;

FIG. 4 is a functional block diagram of a server illustrated in FIG. 1;

FIG. 5 is a diagram illustrating a data structure of tenant information stored in a tenant information storage unit illustrated in FIG. 4;

FIG. 6 is a diagram illustrating a data structure of user information stored in a user information storage unit illustrated in FIG. 4;

FIG. 7 is a diagram illustrating a data structure of log information stored in a log management unit illustrated in FIG. 4;

FIG. 8 is a diagram illustrating a data structure of subscription information stored in a subscription information management unit illustrated in FIG. 4;

FIG. 9 is a diagram illustrating a data structure of publishing information stored in a publishing information management unit illustrated in FIG. 4;

FIG. 10 is a diagram illustrating a data structure of a message type list stored in a message type information management unit illustrated in FIG. 4;

FIG. 11 is a diagram illustrating a data structure of management information stored in a message transmission-reception unit illustrated in FIG. 4;

FIG. 12 is a diagram illustrating a process by the messaging system illustrated in FIG. 4;

FIG. 13 is a diagram illustrating a process by the messaging system illustrated in FIG. 4;

FIG. 14 is a diagram illustrating a process by the messaging system illustrated in FIG. 4;

FIG. 15 is a diagram illustrating a subscriber setting screen according to one embodiment of the present disclosure;

FIG. 16 is a diagram illustrating a publisher setting screen according to one embodiment of the present disclosure;

FIG. 17 is a diagram illustrating a log list screen according to one embodiment of the present disclosure;

FIG. 18 is a diagram illustrating a first example of a log details screen;

FIG. 19 is a diagram illustrating a second example of a log details screen; and

FIG. 20 is a diagram illustrating a workflow according to one embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### System Configuration of Messaging System 10

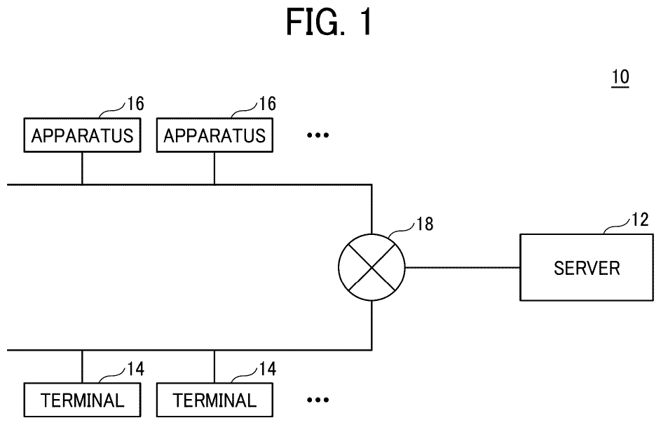

FIG. 1 is a diagram illustrating a system configuration of a messaging system 10.

The messaging system 10 illustrated in FIG. 1 is a so-called publish-subscribe (pub/sub) messaging system that performs messaging between a publisher and a subscriber by a publish-subscribe communication scheme. The messaging system 10 includes a server 12, multiple terminals 14 (information processing terminals), and multiple apparatuses 16. The server 12, the terminals 14, and the apparatuses 16 are connected to communicate to each other through a communication network 18. The communication network 18 is, for example, a local area network (LAN) or the Internet.

The server 12 is an example of a “messaging server” and functions as a service providing system that provides various services. The terminal 14 may be implemented by an information processing terminal such as a personal computer (PC), a smartphone, or a tablet terminal (tablet communication terminal) to be operated by a user. The apparatus 16 is an apparatus such as a multifunction peripheral (MFP), an inkjet printer, or an electronic whiteboard.

Each of the terminals 14 and the apparatuses 16 functions as a “second terminal” used by a “publisher (a sender of a message)” in the pub/sub messaging system and a “first terminal” used by a “subscriber (a receiver of a message)” in the pub/sub messaging system. A message is information transmitted from the publisher, and includes, for example, text data, image data, moving image data, audio data, sensor data, and files in various formats. A publisher is an entity that transmits a message and includes, for example, a user, a device, and an account. A subscriber is an entity that receives the message and includes, for example, a user, a device, and an account. A subscription is setting information related to the transmission or reception of a message.

Receiving a message or performing a setting for receiving a message may be referred to as subscribing, and transmitting a message or performing a setting for transmitting a message may be referred to as publishing.

In other words, each of the terminals 14 and the apparatuses 16 functioning as a “second terminal” used by a “publisher” can transmit a message to multiple “subscribers” (that is, other terminals 14 and other apparatuses 16) via the communication network 18. In the following description, any of the terminals 14 and the apparatuses 16 functioning as a publisher may be referred to as the second terminal.

Each of the terminals 14 and the apparatuses 16 functioning as a “first terminal” used by a “subscriber” can receive a message transmitted from a “second terminal” (that is, any other terminals 14 and other apparatuses 16) used by a “publisher” via the communication network 18. The terminal 14 and the apparatus 16 may receive the message. Instead, the terminal 14 and the apparatus 16 may access the server 12 and display the message stored on the server 12 without receiving the message. In the following description, any of the terminals 14 and the apparatuses 16 functioning as a subscriber may be referred to as the first terminal.

In principle, the “publisher” can collectively transmit a message without designating the transmission destination of the message, and each of the “subscribers” can receive the message when the message type registered in advance is set in the message transmitted from the “publisher.” In the following description, enabling a subscriber to refer to a message generated by a publisher may be referred to as transmitting or receiving a message. That is, transmitting a message includes not only transmitting a message from the terminal 14 or the apparatus 16 to another terminal 14 and another apparatus 16 but also generating a message on the server 12. Further, receiving a message includes not only receiving the message from the terminal 14, the apparatus 16, or the server 12 by the other terminal 14 and the other apparatus 16 but also referring to the message generated on the server 12 by the other terminal 14 and the other apparatus 16 accessing the server 12.

### Hardware Configuration of Server 12 and Terminal 14

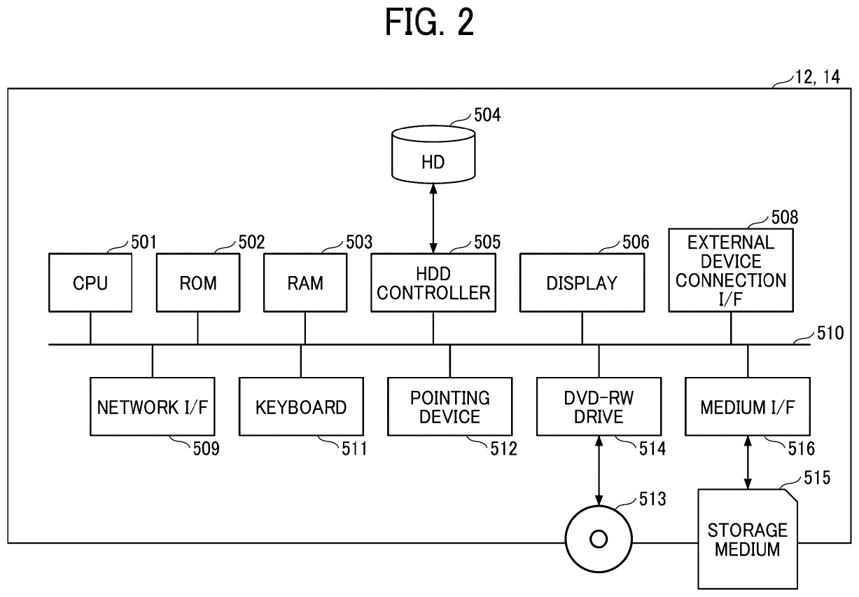

FIG. 2 is a block diagram illustrating a hardware configuration applicable to the server 12 and the terminal 14. The hardware configuration common to the server 12 and the terminal 14 is described below. Specifically, the hardware configuration described below is when the terminal 14 is a PC.

As illustrated in FIG. 2, each of the server 12 and the terminal 14 is implemented by a computer. The computer includes a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a data bus 510, a keyboard 511, a pointing device 512, a digital versatile disk rewritable (DVD-RW) drive 514, and a medium I/F 516.

The CPU 501 controls the entire operation of the server 12 or the terminal 14. The ROM 502 stores programs, such as an initial program loader (IPL), for driving the CPU 501. The RAM 503 is used as a work area for the CPU 501. The HD 504 is a storage area that stores various data such as a program. The HDD controller 505 controls an HDD to read or write various kinds of data from or to the HD 504 under the control of the CPU 501. The display 506 displays various kinds of information such as a cursor, a menu, a window, characters, or an image. The external device connection I/F 508 is an interface for connecting to various external devices. Examples of the external device include, but are not limited to, a universal serial bus (USB) memory and a printer. The network I/F 509 is an interface for data communication via the communication network 18. The data bus 510 is, for example, an address bus or a data bus that electrically connects components such as the CPU 501 illustrated in FIG. 2.

The keyboard 511 is a kind of input device including keys used to input a character, a numerical value, and various instructions. The pointing device 512 is an example of an input device that allows a user to select or execute various instructions, select a target for processing, or move a cursor being displayed. The DVD-RW drive 514 reads and writes various data from and to a DVD-RW 513, which is an example of a removable recording medium. The removable recording medium is not limited to a DVD-RW and may be digital versatile disc-recordable (DVD-R) or the like. The medium I/F 516 controls the reading or writing (storing) of data from or to a recording medium 515 such as a flash memory.

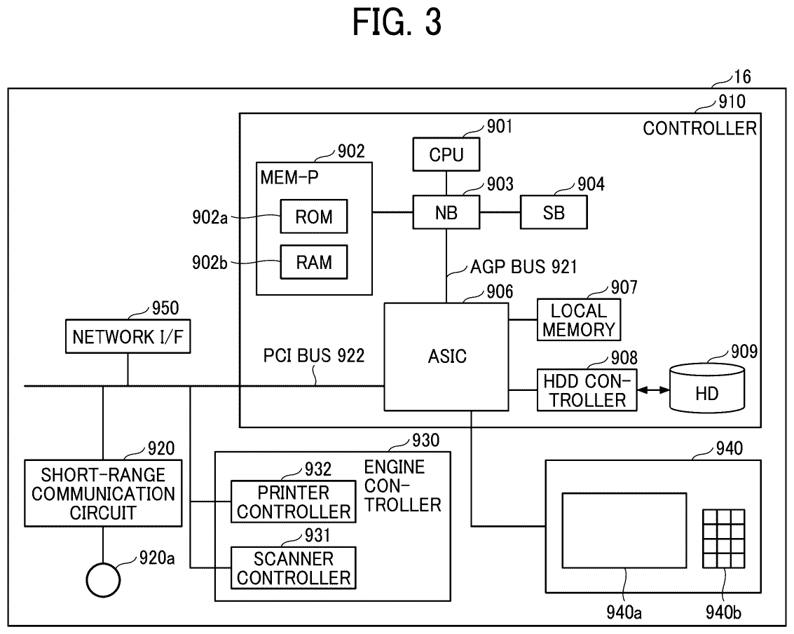

FIG. 3 is a block diagram illustrating a hardware configuration of the apparatus 16. The hardware configuration of the apparatus 16 being an MFP is described below.

As illustrated in FIG. 3, the apparatus 16 includes a controller 910, a short-range communication circuit 920, an engine controller 930, a control panel 940, and a network interface (I/F) 950.

The controller 910 includes a CPU 901 as the main processor of the computer, a system memory 902, a north bridge (NB) 903, a south bridge (SB) 904, an application-specific integrated circuit (ASIC) 906, a local memory 907 as a storage area, a hard disk drive (HDD) controller 908, and a hard disk (HD) 909 as a storage area. The NB 903 and the ASIC 906 are connected via an accelerated graphics port (AGP) bus 921.

The CPU 901 is a controller that controls the entire operation of the apparatus 16. The NB 903 connects the CPU 901, with the system memory 902, SB 904, and AGP bus 921. The NB 903 includes a memory controller for controlling the reading or writing of various data with respect to the system memory 902, a Peripheral Component Interconnect (PCI) master, and an AGP target.

The system memory 902 includes a read-only memory (ROM) 902a and a random-access memory (RAM) 902b. The ROM 902a stores data and programs for implementing various functions of the controller 910. The RAM 902b is used to load the program and the data. The RAM 902b is also used as a memory for loading drawing data for printing. For the purpose of distribution, the program stored in the RAM 902b can be stored in any computer-readable recording medium, such as a compact disc-read only memory (CD-ROM), a compact disc-recordable (CD-R), or a digital versatile disk (DVD), in a file format installable or executable by a computer.

The SB 904 is a bridge that connects the NB 903 with a PCI device or a peripheral device. The ASIC 906 is an integrated circuit (IC) dedicated to image processing and has a hardware element for image processing. The ASIC 906 connects the AGP bus 921, a PCI bus 922, the HDD controller 908, and the local memory 907. The ASIC 906 includes a PCI target, an AGP master, an arbiter (ARB) as a core element of the ASIC 906, a memory controller to control the local memory 907, multiple direct memory access controllers (DMACs), and a PCI unit. The DMACs convert the coordinates of image data with a hardware logic, to rotate the image data. The PCI unit transfers data between a scanner controller 931 and a printer controller 932 through the PCI bus 922. To the ASIC 906, a universal serial bus (USB) interface or an Institute of Electrical and Electronics Engineers (IEEE) 1394 interface may be connected.

The local memory 907 is used as a buffer for image data to be copied or a code buffer. The HD 909 is a storage (memory) that stores various image data, font data for printing, and form data. The HDD controller 908 controls the reading or writing of data from or to the HDD controller 908 under the control of the CPU 901. The AGP bus 921 is a bus interface for a graphics accelerator card, which is proposed to accelerate graphics processing. The speed of the graphics accelerator card is increased through direct accessing to the system memory 902 by high throughput.

The short-range communication circuit 920 is provided with a short-range communication antenna 920a. The short-range communication circuit 920 is a communication circuit in compliance with, for example, near field communication (NFC) or BLUETOOTH.

The engine controller 930 includes the scanner controller 931 and the printer controller 932. The control panel 940 includes a panel display 940a and an operation section 940b. The panel display 940a is, for example, a touch screen that displays current setting values or a selection screen and receives a user input. The operation section 940b includes a numeric keypad and a start key. The numeric keypad receives assigned setting values of image forming parameters such as an image density parameter. The start key receives an instruction to start, e.g., copying. The controller 910 controls the entire operation of the apparatus 16 such as drawing, communication, and inputs to the control panel 940. The scanner controller 931 or the printer controller 932 includes an image processing unit for, for example, error diffusion and gamma conversion.

Note that, in response to an instruction to select a specific application through the control panel 940 by use of, e.g., an application switch key, the apparatus 16 sequentially selects the function from document server, coping, printing, and facsimile transmission functions. When the document server function is selected, the operation mode is changed to a document server mode to store document data. When the copy function is selected, the operation mode is changed to a copy mode. When the print function is selected, the operation mode is changed to a printer mode. When the facsimile function is selected, the operation mode is changed to a facsimile mode.

The network I/F 950 is an interface circuit for performing data communication through the communication network 18. The short-range communication circuit 920 and the network I/F 950 are electrically connected to the ASIC 906 via the PCI bus 922.

### Functional Configuration of Server 12

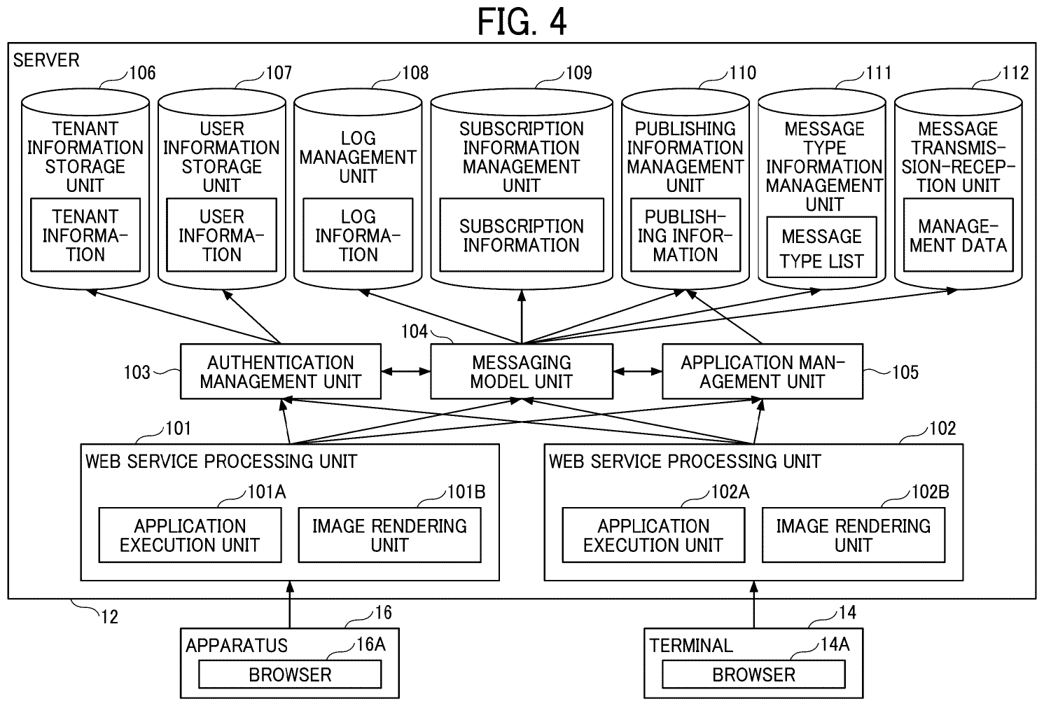

FIG. 4 is a functional block diagram of the server 12.

As illustrated in FIG. 4, the server 12 includes, as functional units of the service providing system, a web service processing unit 101, a web service processing unit 102, an authentication management unit 103, a messaging model unit 104, an application management unit 105, a tenant information storage unit 106, a user information storage unit 107, a log management unit 108, a subscription information management unit 109, a publishing information management unit 110, a message type information management unit 111, and a message transmission-reception unit 112.

The subscription information management unit 109 is an example of a “registration information storing unit.”

The web service processing units 101 and 102 are examples of a “reception unit.” The message transmission-reception unit 112 is an example of a “transmission unit.”

The web service processing unit 101 provides a web application for the apparatus 16.

The web service processing unit 101 includes an application execution unit 101A and an image rendering unit 101B. The application execution unit 101A executes an application. The application execution unit 101A transmits the application information obtained from the application management unit 105 to the apparatus 16, thereby allowing the apparatus 16 to display the application information to the user, and requests the apparatus 16 and the application management unit 105 to execute the application according to the setting by the user. In the case of printing, the application execution unit 101A requests the apparatus 16 to print an image obtained from the application management unit 105. In the case of scanning, the application execution unit 101A requests the apparatus 16 to read an image, passes the result to the application management unit 105, and requests subsequent processing.

The image rendering unit 101B executes screen display of an application on the apparatus 16. For example, the image rendering unit 101B transmits information on the setting screen of the application to the apparatus 16 to allow the apparatus 16 to display the setting screen and receive the setting of the application input by the user of the apparatus 16. That is, the web service processing unit 101 transmits screen information for displaying, e.g., a setting screen to the apparatus 16. The apparatus 16 displays, e.g., a setting screen based on the screen information, receives an operation such as selection from the user, and transmits information indicating the operation result to the web service processing unit 101. Thus, the web service processing unit 101 receives the result of the user's operation performed on the setting screen.

The web service processing unit 102 provides a web application for the terminal 14.

The web service processing unit 102 includes an application execution unit 102A and an image rendering unit 102B. The application execution unit 102A performs the setting of an application and executes the application. The application execution unit 102A receives an input from the user via the terminal 14 and requests the application management unit 105 to change, for example, a default value. The application execution unit 102A requests the authentication management unit 103 to perform authentication for displaying personal settings on the terminal 14. When the authentication on an external service such as a file upload destination is required in the setting of the application, the application execution unit 102A requests the authentication management unit 103 to obtain authentication information. The image rendering unit 102B executes screen display of the application on the terminals 14. For example, the image rendering unit 102B transmits information on a parameter setting screen to the terminal 14 to allow the terminal 14 to display the setting screen, and receives input of parameters from the user of the terminal 14. That is, the web service processing unit 102 transmits screen information for displaying, for example, a setting screen to the terminal 14. The terminal 14 displays, e.g., a setting screen based on the screen information, receives an operation such as selection from the user, and transmits information indicating the operation result to the web service processing unit 102. Thus, the web service processing unit 102 receives the result of the user's operation performed on the setting screen. In the following description, receiving information indicating an operation result by the web service processing units 101 and 102 from the terminal 14 or the apparatus 16 may be referred to as receiving an operation.

The authentication management unit 103 obtains and updates user information stored in the user information storage unit 107 and tenant information stored in the tenant information storage unit 106. The authentication management unit 103 controls user login and restricts access to devices.

The messaging model unit 104 provides an application programming interface (API) and various kinds of information for executing a pub/sub messaging model.

The application management unit 105 manages (e.g., stores and updates) and provides various applications for the user to use a pub/sub messaging model.

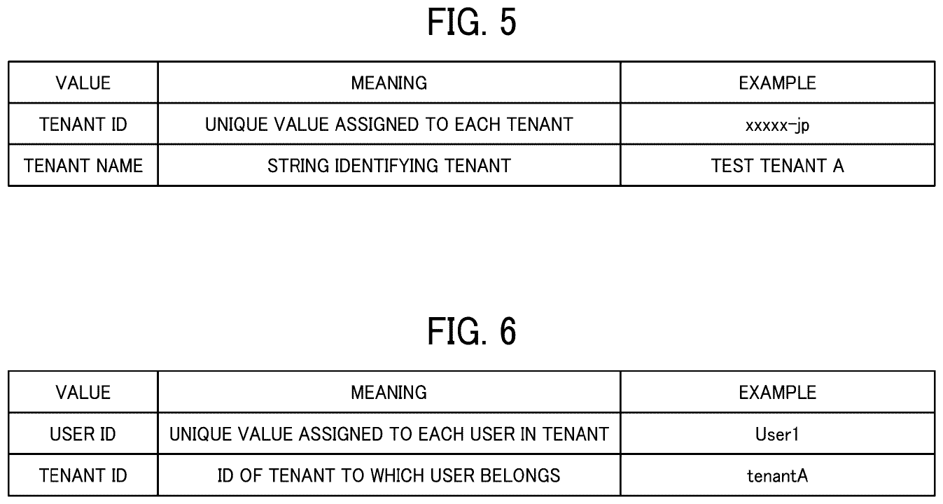

The tenant information storage unit 106 stores tenant information. The term “tenant information” represents information on a group of customers sharing the same software. For example, a group of customers is a company, and the customers include users and devices. FIG. 5 is a diagram illustrating a data structure of the tenant information stored in the tenant information storage unit 106. As illustrated in FIG. 5, the tenant information includes a “tenant identifier (ID)” and a “tenant name.” The “tenant ID” is a unique value assigned to each tenant. The “tenant name” is a character string identifying a tenant. Tenant information is added to, updated, or deleted from the tenant information storage unit 106, for example, by a system administrator.

The user information storage unit 107 stores user information. FIG. 6 is a diagram illustrating a data structure of the user information stored in the user information storage unit 107. As illustrated in FIG. 6, the user information includes a “user ID” and a “tenant ID.” The “user ID” is a unique value in the tenant assigned to each user. The “tenant ID” is the identifier assigned to the tenant to which the user belongs.

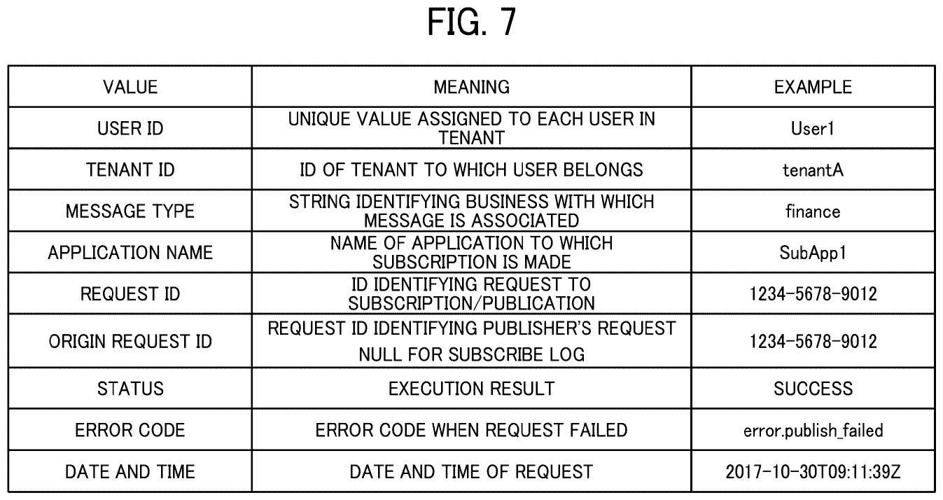

The log management unit 108 manages (e.g., stores and updates) log information about message information transmitted in the pub/sub messaging model. FIG. 7 is a diagram illustrating a data structure of the log information managed by the log management unit 108. As illustrated in FIG. 7, the log information includes a “user ID,” a “tenant ID,” a “message type,” an “application name,” a “request ID,” an “origin request ID,” a “status,” an “error code,” and a “date and time.” The “user ID,” the “tenant ID,” the “message type,” and the “application name” are similar to those used in other information. The “request ID” is an ID for identifying a subscribe/publish request. The “origin request ID” is a request ID identifying a request of a publisher. The “status” indicates the result of execution. For a subscribe log, the “status” is set to “null.” The “error code” is an error code when the request fails. The “date and time” is the date and time when the request is executed.

When a subscriber receives a message, the subscriber can automatically or manually execute a predetermined operation or process based on the received message. The log management unit 108 may store log information on the operation or process executed by a subscriber. In this case, the log information includes the content of the operation or the process executed by the subscriber, and the information on the date and time of execution.

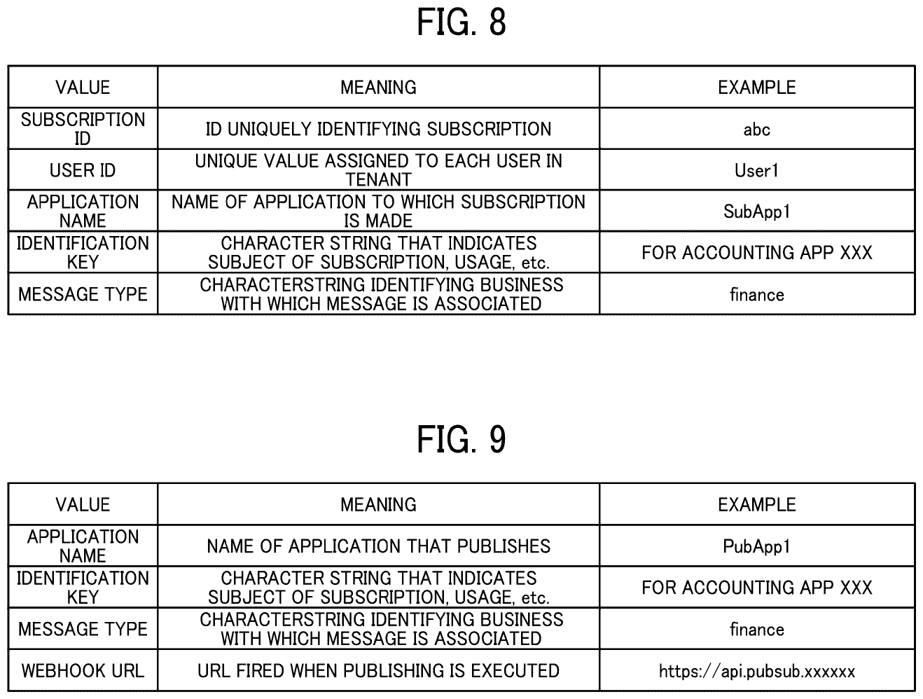

The subscription information management unit 109 stores subscription information. The subscription information is setting information related to the reception of a message and is an example of “registration information.” FIG. 8 is a diagram illustrating a data structure of the subscription information stored in the subscription information management unit 109. As illustrated in FIG. 8, the subscription information includes a “subscription ID,” a “user ID,” an “application name,” an “identification key,” and a “message type.” The “subscription ID” is an ID that uniquely identifies a subscription. The “user ID” is a unique value in the tenant assigned to each user.

The “application name” is the name of an application that performs a subscription. The “identification key” is an example of “identification information” and is any character string representing, for example, a person who subscribes or the purpose of a subscription. The “message type” is information indicating an attribute of a message and is, for example, a character string identifying the business or work associated with the message.

The publishing information management unit 110 stores publishing information. The publishing information is setting information related to the transmission of a message and is an example of “registration information.” The subscription information may be referred to as first registration information, and the publishing information may be referred to as second registration information. FIG. 9 is a diagram illustrating a data structure of the publishing information stored in the publishing information management unit 110. As illustrated in FIG. 9, the publishing information includes an “application name,” an “identification key,” a “message type,” and a “webhook uniform resource locator (URL).” The “application name” is the name of an application that performs publishing. The “identification key” is any character string that represents, for example, a person who subscribes or the purpose of the subscription. The “message type” is a character string identifying the business or work associated with the message. The “webhook URL” is a URL that is fired when publishing is executed. That is, the server 12 can transmit a message to the URL indicated by the webhook URL. In the following description, transmitting a request to a URL for executing a predetermined process may be referred to as firing the URL, and transmitting a message may be referred to as firing publishing.

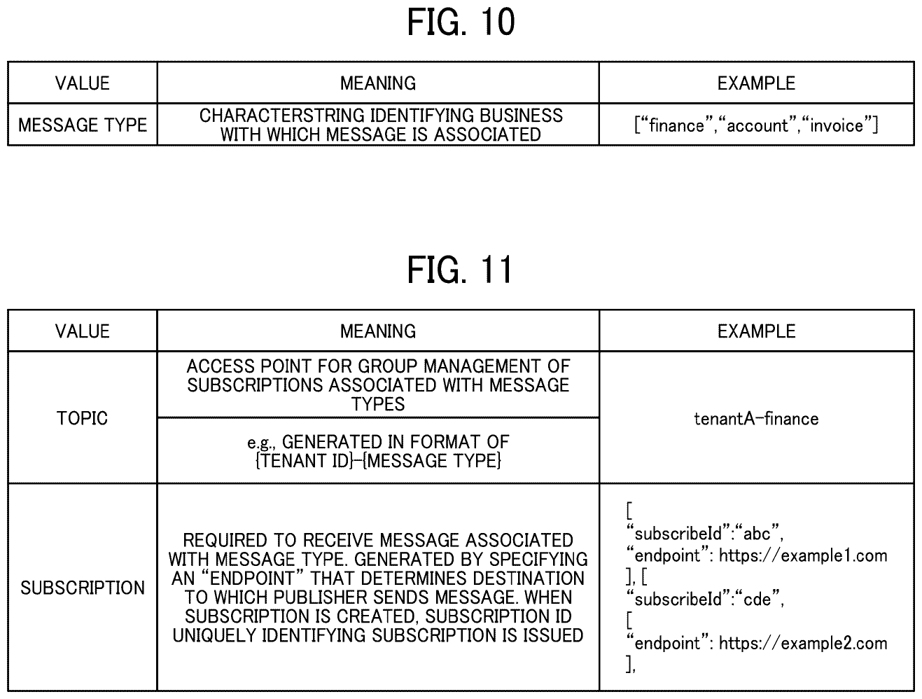

The message type information management unit 111 stores a list of available message types, which may be referred to as a message type list in the following description. FIG. 10 is a diagram illustrating a data structure of the message type list stored in the message type information management unit 111. As illustrated in FIG. 10, the message type list includes “message type.” The “message type” is a list of character strings each of which identifies the business or work associated with the message.

The message transmission-reception unit 112 transmits messages, receives messages, and stores management information for transmitting and receiving messages. FIG. 11 is a diagram illustrating a data structure of the management information stored in the message transmission-reception unit 112. As illustrated in FIG. 11, the management information includes “topic” and “subscription.” The “topic” is an access point for grouping and managing subscriptions associated with a message type. In the present embodiment, a topic is created in the form of {tenant ID}-{message type}. The “subscription” is for receiving a message associated with the message type. The “subscription” is created by specifying an “endpoint” that determines the destination of the message sent from the publisher. When a subscription is created, a subscription ID that uniquely identifies the subscription is issued.

As illustrated in FIG. 4, the terminal 14 (e.g., a PC, a smartphone, or a tablet terminal) includes a browser 14A that is an application. The browser 14A downloads and executes a program in a format such as JAVASCRIPT or cascading style sheets (CSS) provided by the web service processing unit 102.

As illustrated in FIG. 4, the apparatus 16 (e.g., an MFP, an inkjet printer, or an electronic whiteboard) includes a browser 16A, which is an application. The browser 16A downloads and executes a program in a format such as JAVASCRIPT or CSS provided by the web service processing unit 101.

The functions of the server 12 described above are implemented by, for example, the CPU of the server 12 executing a program.

The above-described functionality of the server 12 may be implemented by one or multiple processing circuits. The “processing circuit or circuitry” in the present specification includes a programmed processor to execute each function by software, such as a processor implemented by an electronic circuit, and devices, such as an application-specific integrated circuit (ASIC), a digital signal processor (DSP), a field programmable gate array (FPGA), and conventional circuit modules arranged to perform the recited functions.

In FIG. 4, the functional configuration of the server 12 is divided into blocks of functions for ease of understanding of the operation by the server 12. No limitation is intended by how the processing units are divided by the unit of process or by the name. The processing executed by the server 12 may be divided into a greater number of processing units in accordance with the contents of the processing. Alternatively, a single processing unit may be divided into multiple processing units.

### Process Performed by Messaging System 10

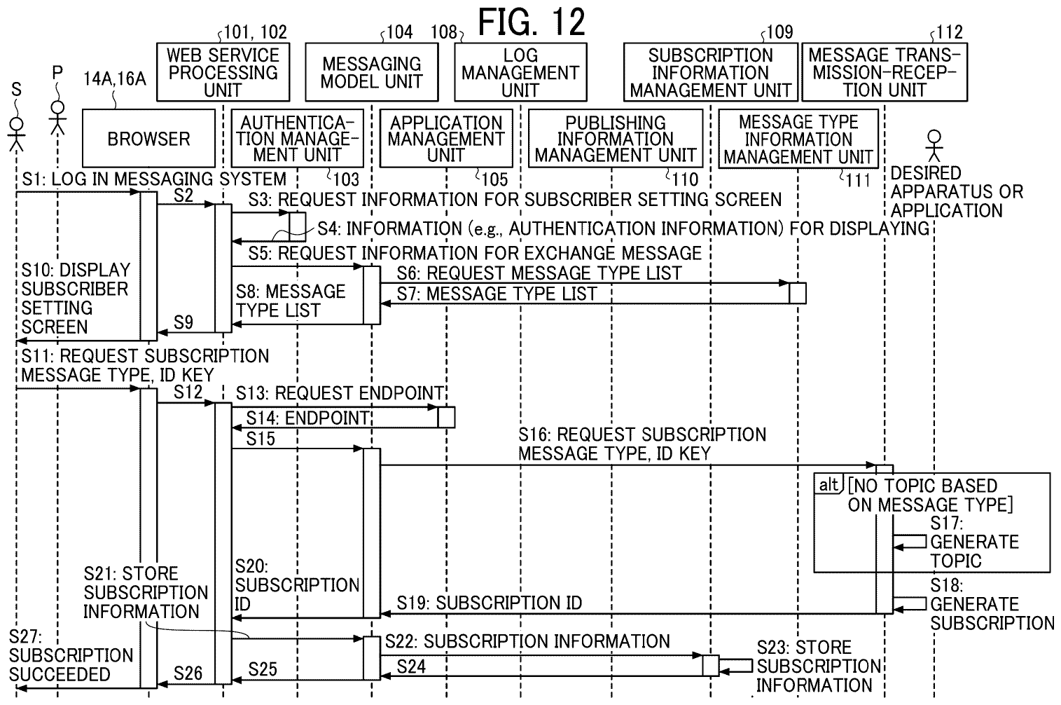

FIGS. 12 to 14 are diagrams each illustrating a process performed by the messaging system 10.

### Execution of Subscription

FIG. 12 illustrates a process performed by the messaging system 10 when a subscriber S performs a subscription (performs the setting for receiving messages).

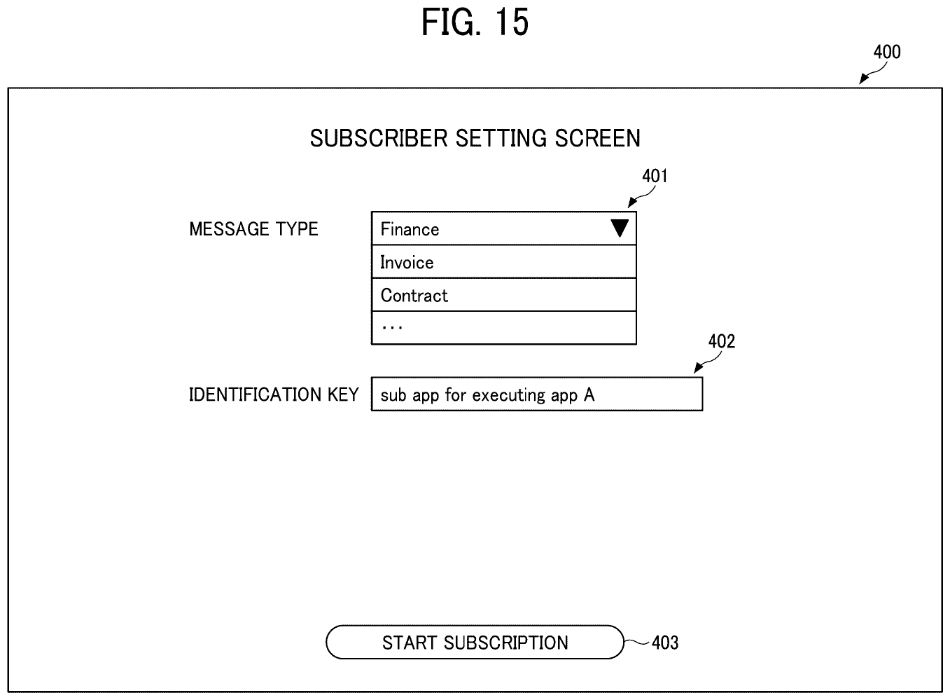

In the process illustrated in FIG. 12, in S1, the subscriber S logs in the messaging system 10 from the browser 14A or 16A on the display of the terminal 14 or the display of the apparatus 16, to open the application. In S2, the browser 14A or 16A requests the display of a subscriber setting screen. That is, in S2, the browser 14A or 16A requests execution of a program provided by the web service processing unit 101 or 102. In S3 to S4, the web service processing unit 101 or 102 obtains information for a subscriber setting screen from the authentication management unit 103. In S5 to S8, the web service processing unit 101 or 102 obtains a message type list from the message type information management unit 111 via the messaging model unit 104. In S9, the web service processing unit 101 or 102 transmits the screen information to the browser 14A or 16A to display the subscriber setting screen (see FIG. 15) on the browser 14A or 16A in S10.

In S11, the subscriber S selects a message type to be subscribed, inputs a character string as an identification key, and presses a save button on the subscriber setting screen. In S12, the browser 14A or 16A receives the operation by the subscriber S and transmits to the web service processing unit 101 or 102 a request for executing subscription (i.e., message reception setting). The identification key may be determined in advance between a publisher P and the subscriber S. One subscriber S can create multiple subscriptions. For example, one subscriber S creates, for one message type, two subscriptions with different identification keys.

In S13 to S14, the web service processing unit 101 or 102 obtains an endpoint for the subscription from the application management unit 105. The endpoint is randomly generated by the application management unit 105, but a predetermined destination may be set. In S15 to S16, the web service processing unit 101 or 102 requests the message transmission-reception unit 112 to execute the subscription via the messaging model unit 104.

In S16, the message transmission-reception unit 112 receives information (message type and endpoint) for the subscription from the messaging model unit 104. When there is no topic, the message transmission-reception unit 112 generates a topic in S17 and generates a subscription belonging to the topic in S18. In S19 to S20, the message transmission-reception unit 112 returns the subscription ID to the web service processing unit 101 or 102 via the messaging model unit 104.

When the subscription through the message transmission-reception unit 112 is successful, in S21 to S23, the web service processing unit 101 or 102 requests to store the subscription information in the subscription information management unit 109 via the messaging model unit 104. In S24 to S25, the result of the request is transmitted to the web service processing unit 101 or 102. This allows each subscriber S to refer to the information such as the type of message subscribed to and the identification key.

The web service processing unit 101 or 102 notifies the subscriber S of the success of the subscription via the browser 14A or 16A in S26 to S27.

### After Execution of Subscription

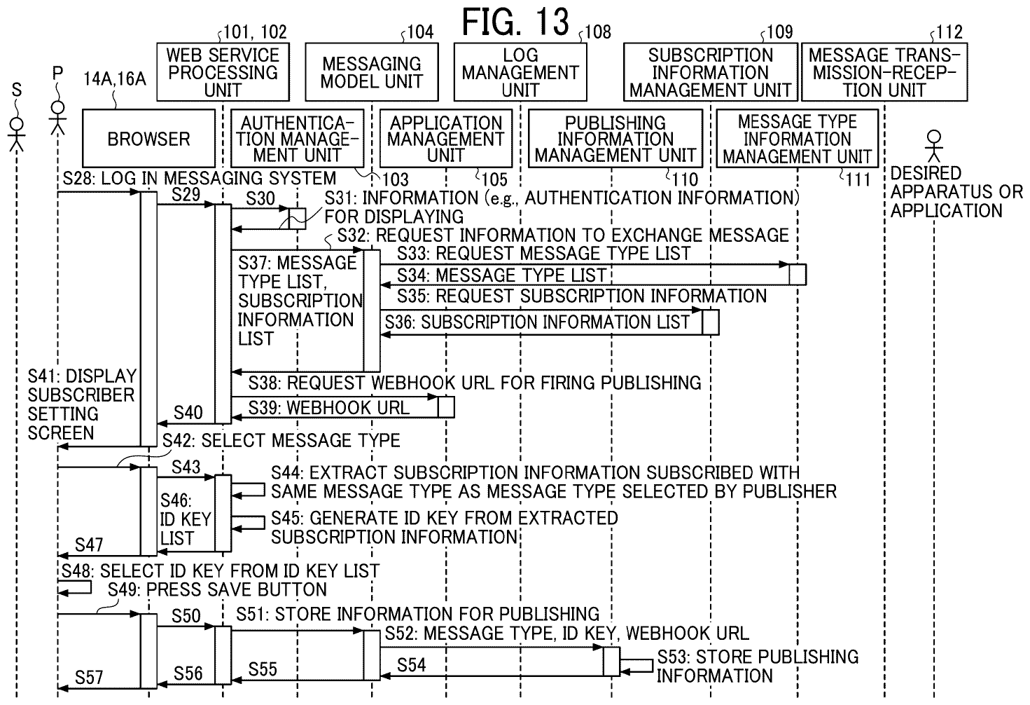

FIG. 13 illustrates a process performed by the messaging system 10 after the subscriber S executes the subscription (setting for receiving messages).

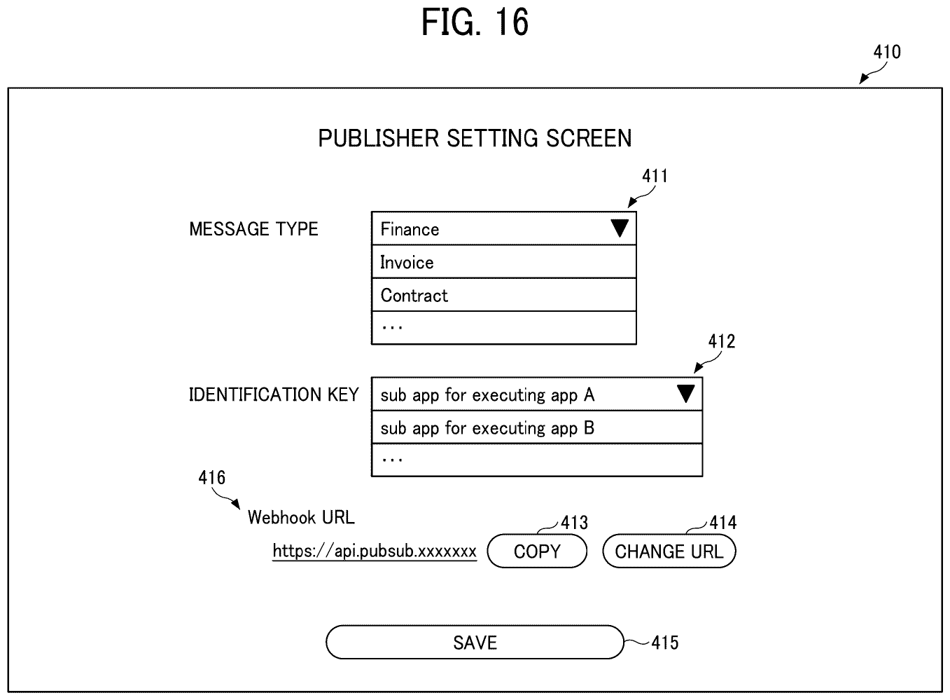

In the process illustrated in FIG. 13, in S28, the publisher P logs in to the messaging system 10 from the browser 14A or 16A. In S29, the browser 14A or 16A executes the program provided by the web service processing unit 101 or 102. In S30 to S31, the web service processing unit 101 or 102 obtains information for a publisher setting screen from the authentication management unit 103. In S32, the web service processing unit 101 or 102 requests the messaging model unit 104 to transmit a message type list and a subscription information list. As a result, the message type list is obtained from the message type information management unit 111 (in S33 to S34), and the subscription information list is obtained from the subscription information management unit 109 (in S35 to S36). In S37, the messaging model unit 104 transmits the message type list and the subscription information list to the web service processing unit 101 or 102. In S38 to S39, the web service processing unit 101 or 102 obtains a webhook URL for firing the publication from the application management unit 105. In S40, the web service processing unit 101 or 102 transmits the screen information to the browser 14A or 16A to display the publisher setting screen (see FIG. 16) on the browser 14A or 16A in S41.

In S42, the publisher P selects a message type on the publisher setting screen. In S43, the browser 14A or 16A transmits the selection to the web service processing unit 101 or 102. The web service processing unit 101 or 102 obtains multiple pieces of subscription information corresponding to the message type from the obtained subscription information list in S44. In S45, the web service processing unit 101 or 102 generates a list of identification keys set for subscriptions from the obtained subscription information. In S46 to S47, the web service processing unit 101 or 102 transmits the screen information to display the identification key list on the publisher setting screen.

In S48, the publisher S selects an identification key on the publisher setting screen and presses the save button. From S49 to S50, the web service processing unit 101 or 102 receives pressing the save button. In S51 to S52, the web service processing unit 101 or 102 requests to store the publishing information including the message type and the identification key selected by the publisher P in the publishing information management unit 110 via the messaging model unit 104. In S53, the publishing information is stored, and the result is returned in S54 and S55.

The web service processing unit 101 or 102 notifies the publisher P via the browser 14A or 16A that publishing information is stored in S56 to S57.

### After Storing Publishing Information

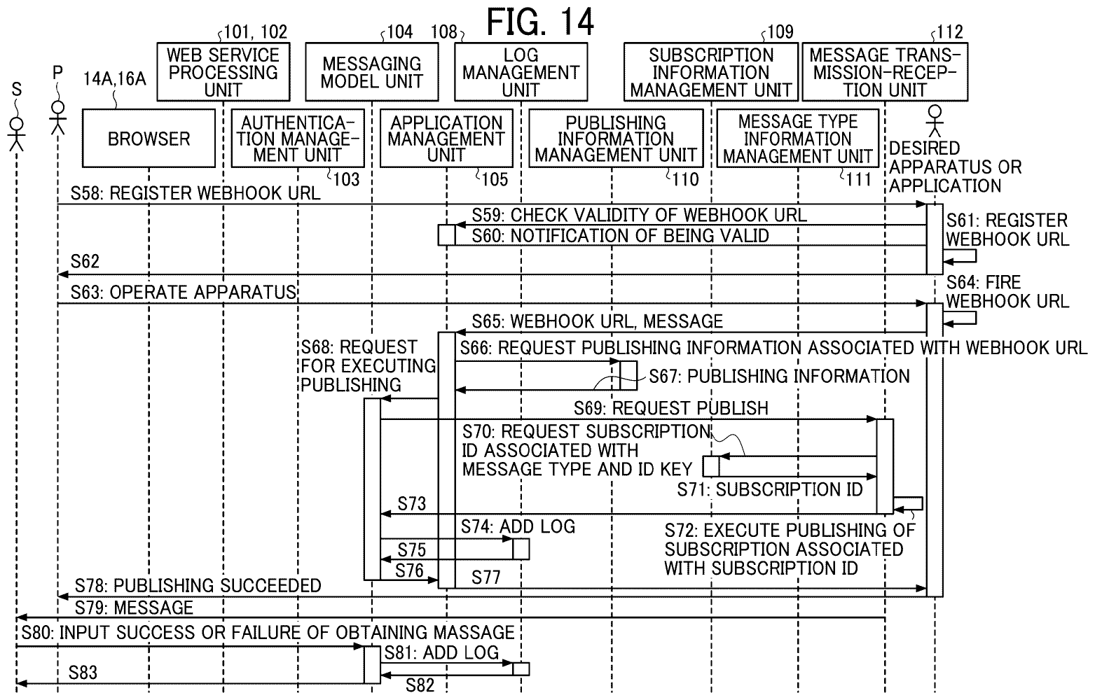

FIG. 14 illustrates a process performed by the messaging system 10 after the publisher P stores the publishing information.

In the process illustrated in FIG. 14, in S58, the publisher P registers the webhook URL displayed on the publisher setting screen in any desirable apparatus or application.

This allows the desirable apparatus or application to fire the webhook URL when executing a predetermined process (for example, scanning an image or adding data to a table). The webhook URL is an example of the setting for executing the publishing, but the setting for executing the publishing may be another setting.

When firing the webhook URL in S64, the desirable apparatus or application transmits the webhook URL and a message to the application management unit 105 in S65. In this example, the message transmitted is data associated with the operation of the apparatus or application). In S66 to S67, the application management unit 105 obtains the publishing information associated with the webhook URL from the publishing information management unit 110. In S68, the application management unit 105 requests the execution of publishing. In response to this request, the messaging model unit 104 requests the message transmission-reception unit 112 to execute the publishing in S69.

The message transmission-reception unit 112 specifies the subscription ID of the subscription having the message type and the identification key same as those set in the publishing information from the subscription information management unit 109, to obtain the subscription ID (S70 to S71).

In S72, the message transmission-reception unit 112 executes the publishing of the subscription associated with the obtained subscription ID. Specifically, the message transmission-reception unit 112 transmits the message only to the subscriber S who has registered the message type and the identification key same as those associated with the obtained subscription ID. In other words, the subscriber who receives the message can be set by setting the message type and the identification key.

In S73, the message transmission-reception unit 112 returns the execution result of the publishing to the messaging model unit 104. The messaging model unit 104 requests the log management unit 108 to store the execution result of the publishing in the log in S74 to S75. In S76 to S77, the messaging model unit 104 transmits the execution result of the publishing via the application management unit 105 to the apparatus or application in which the webhook URL has been registered in S58.

The message transmission-reception unit 112 may obtain the tenant information of the publisher P and the subscriber S to specify the subscription ID generated by the subscriber S belonging to the same tenant as the publisher P (or belonging to a tenant different from the publisher P) among the obtained subscription IDs, to transmit the message.

In the description above, a mechanism for publishing data associated with an operation of an apparatus or application as a message is proposed, the mechanism proposed is not limited thereto. For example, a message may be set on the publisher setting screen, and the publishing may be fired when the save button is pressed. Further, for example, information for publishing may be set, stored, and published by any desired apparatus or application.

In S79, the subscriber S receives the message transmitted from the message transmission-reception unit 112 on the browser 14A or 16A. In S80, the subscriber S inputs on the publisher setting screen the success or failure of the reception of the message, which is transmitted to the messaging model unit 104 via the web service processing unit 101 or 102. The messaging model unit 104 requests the log management unit 108 to store the success or failure of the reception of the message in the log in S81. In S82, the log is added, and the result is transmitted to the browser 14A or 16A in S83.

The subscriber S can delete the created subscription at any desired time. For example, the subscriber S can select a subscription to be deleted from a subscription list or designate a subscription to be deleted by specifying a message type and an identification key, and can request the server 12 to delete the subscription. The server 12 deletes the designated subscription in response to the request from the subscriber S. After that, the server 12 may control the identification key assigned to the deleted subscription not to be displayed on the publisher setting screen.

### Subscriber Setting Screen

FIG. 15 is a diagram illustrating a subscriber setting screen 400. The subscriber setting screen 400 illustrated in FIG. 15 is displayed by the browser 14A or 16A when the subscriber S performs a subscription.

As illustrated in FIG. 15, the subscriber S can select any desired message type from a list 401 of message types displayed on the subscriber setting screen 400. The subscriber setting screen 400 includes an identification key input field 402 to receive, from the subscriber S, the input of any desired character string as an identification key.

In FIG. 15, the subscriber setting screen 400 has a save button 403 labeled “start subscription.” The subscriber S can request the web service processing unit 101 or 102 to execute the subscription including the selected message type and the input identification key by pressing the save button 403 on the subscriber setting screen 400.

### Publisher Setting Screen

FIG. 16 is a diagram illustrating a publisher setting screen 410. The publisher setting screen 410 illustrated in FIG. 16 is an example of the “reception screen” and is displayed by the browser 14A or 16A when the publisher P stores the publishing information.

As illustrated in FIG. 16, the publisher P can select any desired message type from a list 411 of message types displayed on the publisher setting screen 410. The publisher setting screen 410 includes an apparatus key list 412 to receive the selection of an identification key by the publisher P.

As illustrated in FIG. 16, the publisher setting screen 410 displays a webhook URL 416, a copy button 413, and a URL change button 414. The publisher P can copy the webhook URL 416 by pressing the copy button 413. The publisher P can change the webhook URL 416 by pressing the URL change button 414.

The publisher setting screen 410 illustrated in FIG. 16 includes a save button 415 labeled “save.” The publisher P can request the web service processing unit 101 or 102 to store the publishing information including the selected message type and identification key by pressing the save button 415 on the publisher setting screen 410.

The publisher setting screen 410 displays a list of identification keys input by the subscriber S. In particular, the publisher setting screen 410 displays, as identification keys selectable by the user, a list of only identification keys corresponding to the message type selected by the publisher P among the identification keys. For example, it is assumed that a subscriber A inputs a message type A and an identification key A, a subscriber B inputs a message type B and an identification key B, and a subscriber C inputs a message type A and an identification key C. In this situation, when the publisher P selects the message type A on the publisher setting screen 410, the publisher setting screen 410 displays the identification keys A and C in a list of identification keys selectable by the user. That is, the publisher setting screen 410 can hide (set to not-display) the identification key B which does not match the message type selected by the publisher P. The publisher setting screen 410 may display the identification keys sorted in any order designated by the publisher P or the system administrator, or may display the identification keys sorted in the order of, for example, registration, expiration date, or name.

### Log List Screen

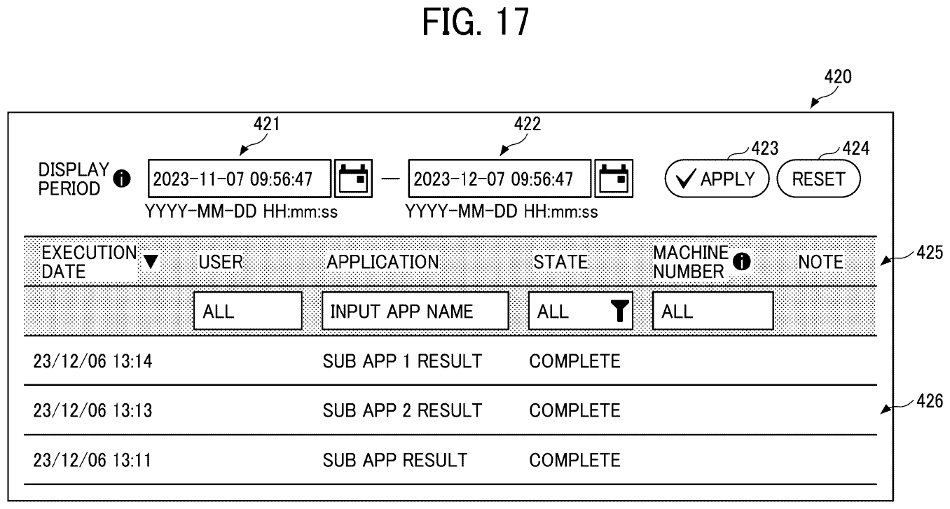

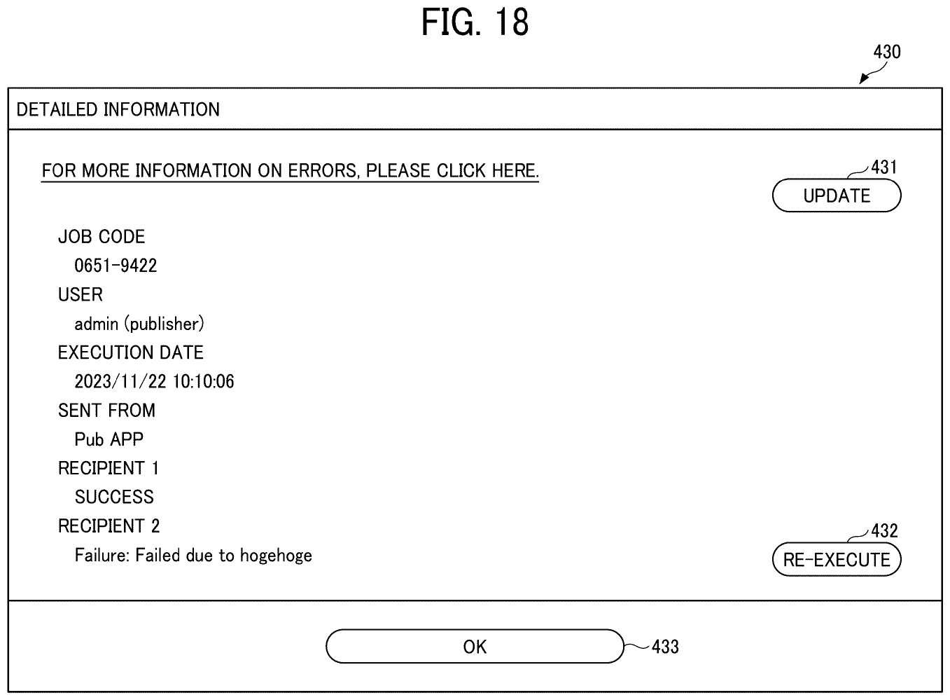

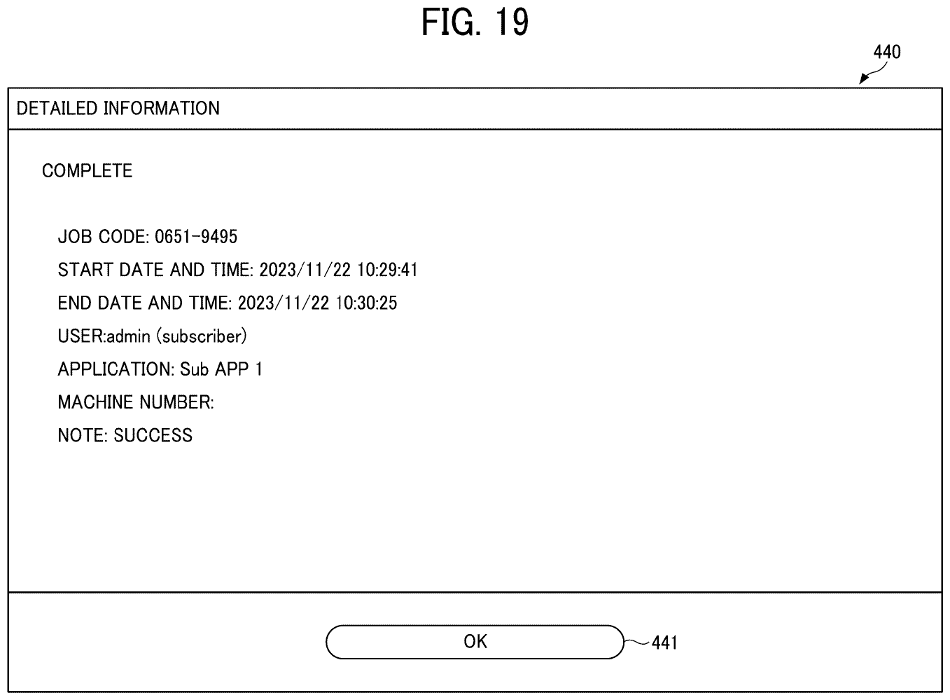

FIG. 17 is a diagram illustrating a log list screen 420. In the log list screen 420 illustrated in FIG. 17 includes a log display field 426 in which a list of logs stored in the log management unit 108 is displayed. The server 12 displays the log list screen 420 illustrated in FIG. 17 on the apparatus used by the user in response to a request from the user. When the user selects a log on the log list screen 420 illustrated in FIG. 17, the server 12 controls the apparatus used by the user to display a detail screen (see FIGS. 18 and 19) illustrating the details of the log.

The log list screen 420 displays logs within a period designated by the user in a log display field 426 when the user presses an apply button 423 on the log list screen 420 on which a start time is designated in a start time field 421 and an end time is designated in an end time field 422. Further, when the user presses a reset button 424, the log list screen 420 resets the start time field 421 and the end time field 422. The log list screen 420 includes a condition input field 425 and a log display field 426 in which logs matching the conditions input to the condition input field 425 by the user are displayed.

### First Example of Log Details Screen

FIG. 18 is a diagram illustrating a log details screen 430. The log details screen 430 illustrated in FIG. 18 displays the transmission result of the message by the publisher and logs related to the individual reception results of the message by the subscribers S.

The log details screen 430 includes an update button 431, a re-execute button 432, and an OK button 433. When the user presses the update button 431 on the log details screen 430, the latest log is displayed on the log details screen 430. When the user presses a re-execution button 432 on the log details screen 430, the server 12 re-executes the transmission of the message that has failed to be transmitted. When the user presses the OK button 433 on the log details screen 430, the apparatus used by the user ends the display of the log details screen 430.

### Log Details Screen (Second Example)

FIG. 19 is a diagram illustrating a log details screen 440. The log details screen 440 illustrated in FIG. 19 displays the transmission result of the message by the publisher and the log related to the reception result of the message by one subscriber S.

The log details screen 440 includes an OK button 441. When the user presses the OK button 441 on the log details screen 440, the apparatus used by the user ends the display of the log details screen 440.

### Configuration of Workflow

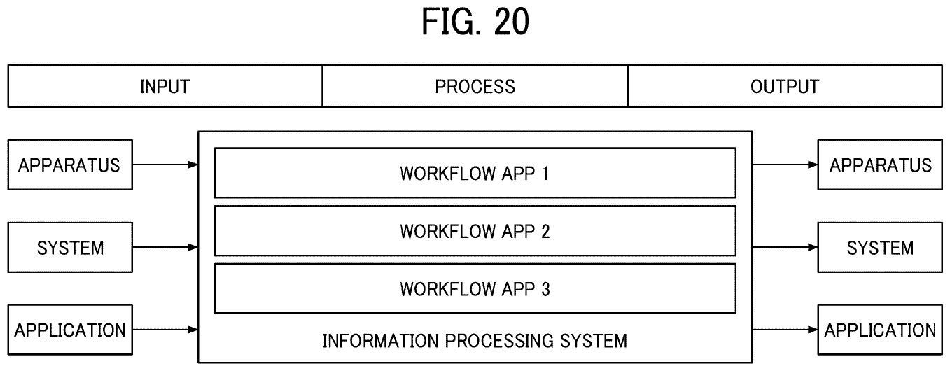

FIG. 20 is a diagram illustrating a configuration of a workflow according to an embodiment of the present disclosure.

The operations according to the embodiments may be implemented by a workflow in which components (input, process, and output components) are combined as illustrated in FIG. 20.

In this case, the input component obtains data (for example, scan data) from an apparatus (for example, an image forming apparatus or an information processing apparatus), and obtains a processing request (for example, addition, modification, or deletion) for data. The process component executes the processing on the data in response to the processing request. The processing is, for example, optical character recognition of scan data.

The output component outputs the processing result of data to, for example, an external server. The output component can transmit the message to a predetermined endpoint as described above. That is, the output component may transmit a message regarding the result of processing in each component triggered by, for example, the reception of data or the processing request by the input component, the execution of predetermined processing by the process component, or the output of data by the output component.

A workflow application that executes a series of processes as a workflow can be created by combining multiple components. Multiple input components, multiple processing components, and multiple output components may together form an application. Also, multiple applications may together form one application.

The processing performed by the input component includes obtaining data from an apparatus. For example, the processing includes obtaining electronic data by scanning or capturing a document or a subject when the apparatus is an MFP or a camera, Alternatively, the processing includes obtaining image data being displayed when the apparatus is a projector or a display. Alternatively, the processing includes obtaining the detection value of the sensor when the apparatus is a senso. Yet alternatively, the processing includes receiving or reading data when the apparatus is a storage server or a storage medium.

The input component can obtain data held in the information processing system that implements the workflow application, but may obtain data from another application or a storage device such as a server. For example, the input component can request a second application different from the workflow application or a second system different from the information processing system that implements the workflow application for data managed by the second application or the second system. The second application can transmit, to the input component being the request source, data managed by the second application or data obtained from a server corresponding to the second application in response to the request. The processing performed by the input component also includes converting a data format to generate data, such as generating text data from image data.

The processing performed by the output component includes processing for outputting data from the apparatus. For example, the processing includes printing electronic data on a medium when the apparatus is an MFP. Alternatively, the processing includes displaying image data or outputting sound when the device is a projector or a display. Alternatively, the processing includes transmitting or storing data when the apparatus is a storage server or a storage medium. The processing further includes transmitting the result of processing or data to a predetermined destination.

The output component can output data to the information processing system that implements the workflow application, but may output data to a second application different from the workflow application or a second system different from the information processing system that implements the workflow application. For example, the output component may request the second application or the second system to manage data or the result of processing. In response to the request, the second application may manage the received data or the result of the processing, or transmit the data or the result of the processing to a server corresponding to the second application so that the data or result is stored therein.

For example, when multiple components are combined, the application can have the following functions.

The input component scans a document with an MFP, thereby generating image data. The process component executes character recognition on the image data, thereby converting the image data into data such as a numerical value or text. The output component transmits the converted data to a business management system that is an example of the second system. The business management system may classify the data received from the workflow application or arrange the data to fit a preset input format, thereby generating management data. The classification of data and the generation of management data may be executed by the process component. In this case, the output component transmits the classification result and the management data to the business management system, and the business management system only needs to store the classification results and management data received from the workflow application in a storage area.

The input component obtains data managed by the business management system.

For example, the input component obtains setting information and data such as a numerical value or text. The input component may request data according to the setting from the business management system or receive data managed by the business management system in response to a request from the business management system. The process component arranges or processes numerical values or text according to the setting information, thereby generating management data. The output component transmits the management data to the business management system. The business management system stores the management data received from the workflow application in a storage area.

The business management system and the workflow application may be provided by different business owners and may be implemented by different servers. In this case, the workflow application communicates with the server implementing the business management system to transmit or receive data to or from the business management system.

As described above, the messaging system 10 that performs messaging between the publisher P and the subscriber S by a publish-subscribe communication scheme includes the subscription information management unit 109 (registration information storing unit) that holds subscription information (registration information) registered via a first terminal by the subscriber S. The subscription information represents the setting of a subscription and includes a message type to be received and an identification key (identification information). The messaging system 10 further includes the web service processing unit 101 or 102 (receiving unit) that receives, from the publisher via a second terminal, selection of a message type to be associated with a message and selection of the identification key (identification information) that corresponds to the selected message type and is received from the subscriber S. The messaging system 10 further includes the message transmission-reception unit 112 (transmission unit) that transmits a message to the subscriber S based on the subscription information (registration information).

With this configuration, the messaging system 10 can transmit a particular message to, among the subscribers S who have registered the type of messages to be received in the subscription information, only the subscriber S who has registered, in the subscription information, the identification key corresponding to the particular transmitted. Thus, the messaging system 10 can transmit a message only to specific subscribers S who want to receive that message, based on the identification key (identification information). As a result, the messaging system 10 can reduce the amount of messages transmitted and received in the system, thereby reducing the load on the server 12 and the communication network 18.

Although the example embodiments of the present disclosure are described above, the above-described embodiments are not intended to limit the scope of the present disclosure. Thus, numerous modifications and replacements of elements are possible within the scope of the above teachings.

For example, the terminal 14 and the apparatus 16 may be any devices that have at least a browser. Examples of the terminal 14 and the apparatus 16 include, but are not limited to, a projector, an output device such as digital signage, a head-up display, an industrial machine, an imaging device, a sound collecting device, a medical device, a network home appliance, a laptop, a mobile phone, a smartphone, a tablet terminal, a game console, a personal digital assistant, a digital camera, a wearable PC, and a desktop PC.

A messaging system that performs publish-subscribe messaging between a publisher and a subscriber includes a server, a first terminal used by the subscriber, and a second terminal used by a publisher. The server includes circuitry to store registration information received from each of one or more subscribers. The registration information represents a subscription setting and includes a message type of messages to be received and identification information. The message type is selected from multiple message types. The circuitry receives, from the publisher, selection of a message type from the multiple message types to be associated with a transmitted, and selection of identification information corresponding to the selected message type from the identification information received from the subscriber. The circuitry transmits the message based on the registration information and the selections by the publisher.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A messaging server comprising circuitry configured to:
store registration information received from each of one or more subscribers, the registration information representing a subscription setting and including a message type of messages to be received and identification information, the message type being selected from multiple message types;
receive, from a publisher, selection of a message type from the multiple message types to be associated with a particular message, the particular message to be transmitted, and selection of identification information corresponding to the selected message type from the identification information received from the subscriber; and
transmit the particular message based on the registration information and the selections by the publisher.

2. The messaging server according to claim 1,
wherein the circuitry is configured to receive, on a reception screen displayed on a display, the selection of the message type and the selection of the identification information, from the publisher.

3. The messaging server according to claim 2, wherein:
the reception screen includes a list of the multiple message types and a list of the identification information, and
the circuitry is configured to receive the selection of the message type from the list of the multiple message types and the selection of the identification information from the list of identification information.

4. The messaging server according to claim 3,
wherein, in a case where the message type is selected from the list of the multiple message types, the circuitry is configured to transmit, to the publisher, screen information representing the reception screen in which the list of the identification information includes the identification information associated with the selected message type.

5. The messaging server according to claim 1,
wherein the circuitry is configured to receive, as the identification information, a character string input by the subscriber.

6. The messaging server according to claim 1,
wherein the circuitry is configured to transmit the particular message only to the subscriber corresponding to the identification information, and the message type associated with the particular message.

7. The messaging server according to claim 6,
wherein the circuitry is configured to transmit the particular message to a webhook URL.

8. A messaging method comprising:
storing registration information received from each of one or more subscribers, the registration information representing a subscription setting and including a message type of messages to be received and identification information, the message type being selected from multiple message types;
receiving, from a publisher, selection of a message type from the multiple message types to be associated with a particular message, the particular message to be transmitted, and selection of identification information corresponding to the selected message type from the identification information received from the subscriber; and
transmitting the particular message based on the registration information and the selections by the publisher.

9. A non-transitory recording medium storing a plurality of program codes which, when executed by one or more processor, causes the processors to perform a messaging method, the method comprising:
storing registration information received from each of one or more subscribers, the registration information representing a subscription setting and including a message type of messages to be received and identification information, the message type being selected from multiple message types;
receiving, from a publisher, selection of a message type from the multiple message types to be associated with a particular message, the particular message to be transmitted, and selection of identification information corresponding to the selected message type from the identification information received from the subscriber; and
transmitting the particular message based on the registration information and the selections by the publisher.
